(19) United States
(12) Patent Application Publication
(10) Pub. No.: US 2015/0277689 A1
(43) Pub. Date: Oct. 1, 2015

(54) DISPLAY INPUT APPARATUS AND COMPUTER-READABLE NON-TRANSITORY RECORDING MEDIUM WITH DISPLAY INPUT CONTROL PROGRAM RECORDED THEREON

(71) Applicant: KYOCERA Document Solutions Inc., Osaka (JP)

(72) Inventor: Shoichi Sakaguchi, Osaka (JP)

(21) Appl. No.: 14/663,258

(22) Filed: Mar. 19, 2015

(30) Foreign Application Priority Data
Mar. 28, 2014 (JP) 2014-067634
Mar. 28, 2014 (JP) 2014-067636

(51) Int. Cl. G06F 3/0485; G06F 3/0482; H04N 1/00; G06F 3/0488

(52) U.S. Cl. CPC G06F 3/0485; G06F 3/04883; G06F 3/0482; H04N 1/00411; H04N 1/00424; H04N 2201/0094

(57) ABSTRACT

A display input apparatus includes a display, a touch panel, a gesture receiving section, a display control section, and a program receiving section. The display control section allows the display to display a setting item list composed of a plurality of setting items lined up in a first direction and a setting candidate list composed of a plurality of setting candidates listed for one of the plurality of setting items and lined up in a second direction, with the setting item list and the setting candidate list across each other. When the gesture receiving section receives a scroll gesture moving from the intersecting region to a predetermined program entry region on the display, the program receiving section receives, as a setting forming part of the program, the setting candidate presented in the intersecting region.

### INCORPORATION BY REFERENCE

This application claims priority to Japanese Patent Application Nos. 2014-067634 and 2014-067636 filed on Mar. 28, 2014, the entire disclosures of both of which are incorporated herein by reference.

### BACKGROUND

The present disclosure relates to display input apparatuses and computer-readable non-transitory recording media with a display input control program recorded thereon and particularly relates to a technique for configuring a program which is a combination of settings of a plurality of setting items.

With the recent trend toward greater functionality of electronic equipment, there emerge image forming apparatuses, mobile terminals, such as smartphones, personal computers, and so on having a large number of user-settable setting items. These pieces of equipment are equipped with a display configured to display a setting item select screen on which a plurality of setting items are presented. When receiving a selection of one setting item on the setting item select screen, such equipment displays a setting change screen on which candidates for the changeable setting of the selected setting item are presented. The equipment receives, based on a user's operation on the setting change screen, a change of the setting and a configuration of a program which is a combination of settings of a plurality of setting items. For example, a technique is known in which a touch panel is disposed in front of a display and a change of a setting and a configuration of a program can be implemented by more intuitive manipulation, such as by receiving the change of each setting via touch gestures or the like on the touch panel.

### SUMMARY

A technique improved over the aforementioned technique is proposed as one aspect of the present disclosure.

A display input apparatus according to an aspect of the present disclosure includes a display, a touch panel, a gesture receiving section, a display control section, and a program receiving section.

The touch panel is disposed in front of the display.

The gesture receiving section is configured to receive a user's gesture on the touch panel.

The display control section is configured to control a display operation of the display according to a user's gesture received by the gesture receiving section.

The program receiving section is configured to receive a program consisting of a combination of settings of a plurality of setting items according to a user's gesture received by the gesture receiving section.

The display control section allows the display to display a setting item list composed of the plurality of setting items lined up in a first direction and a setting candidate list composed of a plurality of setting candidates listed for one of the plurality of setting items and lined up in a second direction different from the first direction, with the setting item list and the setting candidate list across each other, allows, when the gesture receiving section receives a scroll gesture in the first direction, the display to provide a scrolling display of the setting item list and display the setting candidate list composed of a plurality of setting candidates for the setting item presented in an intersecting region of the setting item list and the setting candidate list by the scrolling display, and allows, when the gesture receiving section receives a scroll gesture in the second direction, the display to provide a scrolling display of the setting candidate list.

When the gesture receiving section receives a scroll gesture moving from the intersecting region to a predetermined program entry region on the display, the program receiving section receives, as a setting forming part of the program, the setting candidate presented in the intersecting region.

A computer-readable non-transitory recording medium according to another aspect of the present disclosure contains a display input control program recorded thereon.

The display input control program allows a computer to function as a gesture receiving section, a display control section, and a program receiving section. The gesture receiving section is configured to receive a user's gesture on a touch panel. The display control section is configured to control a display operation of a display according to a user's gesture received by the gesture receiving section. The program receiving section is configured to receive a program consisting of a combination of settings of a plurality of setting items according to a user's gesture received by the gesture receiving section.

The display input control program further allows the computer to function so that the display control section allows the display to display a setting item list composed of the plurality of setting items lined up in a first direction and a setting candidate list composed of a plurality of setting candidates listed for one of the plurality of setting items and lined up in a second direction different from the first direction, with the setting item list and the setting candidate list across each other, allows, when the gesture receiving section receives a scroll gesture in the first direction, the display to provide a scrolling display of the setting item list and display the setting candidate list composed of a plurality of setting candidates for the setting item presented in an intersecting region of the setting item list and the setting candidate list by the scrolling display, and allows, when the gesture receiving section receives a scroll gesture in the second direction, the display to provide a scrolling display of the setting candidate list.

The display input control program further allows the computer to function so that when the gesture receiving section receives a scroll gesture moving from the intersecting region to a predetermined program entry region on the display, the program receiving section receives, as a setting forming part of the program, the setting candidate presented in the intersecting region.

### BRIEF DESCRIPTION OF THE DRAWINGS

FIG. 1 is a perspective view showing the appearance of an image forming apparatus as an example of a display input apparatus according to Embodiment 1 of the present disclosure.

FIG. 2 is a functional block diagram showing an essential internal configuration of the image forming apparatus as an example of the display input apparatus according to Embodiment 1 of the present disclosure.

FIGS. 3A, 3B, and 3C show display examples of a setting screen displayed on a display of the image forming apparatus according to Embodiment 1 of the present disclosure.

FIG. 4 is a flowchart showing a processing flow of the image forming apparatus according to Embodiment 1 of the present disclosure.

FIGS. 5A and 5B show other display examples of the setting screen displayed on the display of the image forming apparatus according to Embodiment 1 of the present disclosure.

FIGS. 6A and 6B show other display examples of the setting screen displayed on the display of the image forming apparatus according to Embodiment 1 of the present disclosure.

FIGS. 7A, 7B, and 7C show other display examples of the setting screen displayed on the display of the image forming apparatus according to Embodiment 1 of the present disclosure. FIG. 8 is a functional block diagram showing an essential internal configuration of an image forming apparatus as an example of a display input apparatus according to Embodiment 2 of the present disclosure.

FIGS. 9A, 9B, and 9C show display examples of a setting screen displayed on a display of the image forming apparatus according to Embodiment 2 of the present disclosure.

FIG. 10 is a flowchart showing a processing flow of the image forming apparatus according to Embodiment 2 of the present disclosure. FIGS. 11A, 11B, and 11C show other display examples of the setting screen displayed on the display of the image forming apparatus according to Embodiment 2 of the present disclosure.

FIGS. 12A and 12B show other display examples of the setting screen displayed on the display of the image forming apparatus according to Embodiment 2 of the present disclosure.

FIGS. 13A, 13B, and 13C show other display examples of the setting screen displayed on the display of the image forming apparatus according to Embodiment 2 of the present disclosure.

FIG. 14 shows a mobile terminal equipped with a display input apparatus according to one embodiment of the present disclosure.

### DETAILED DESCRIPTION

Hereinafter, a description will be given of a display input apparatus and a computer-readable non-transitory recording medium with a display input control program recorded thereon, both according to one embodiment of the present disclosure, with reference to the drawings.

### <Embodiment 1>

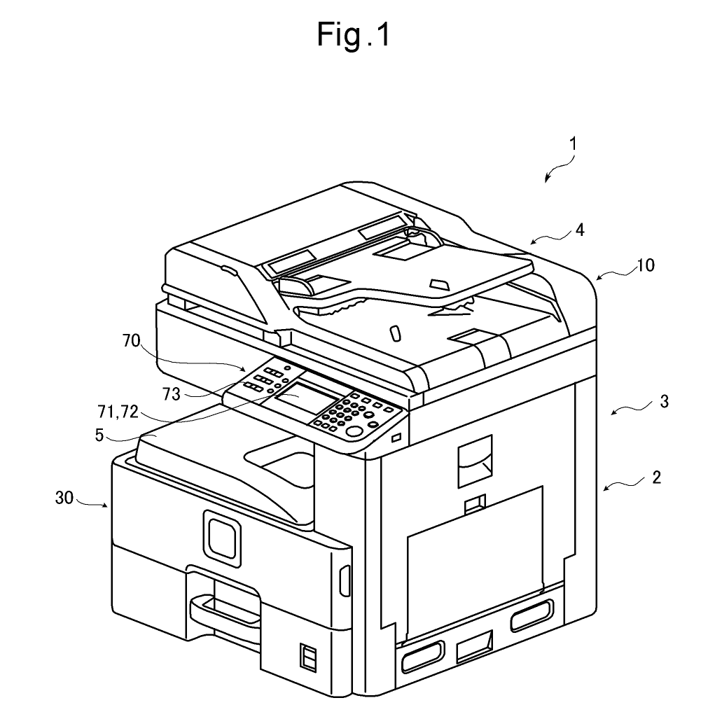

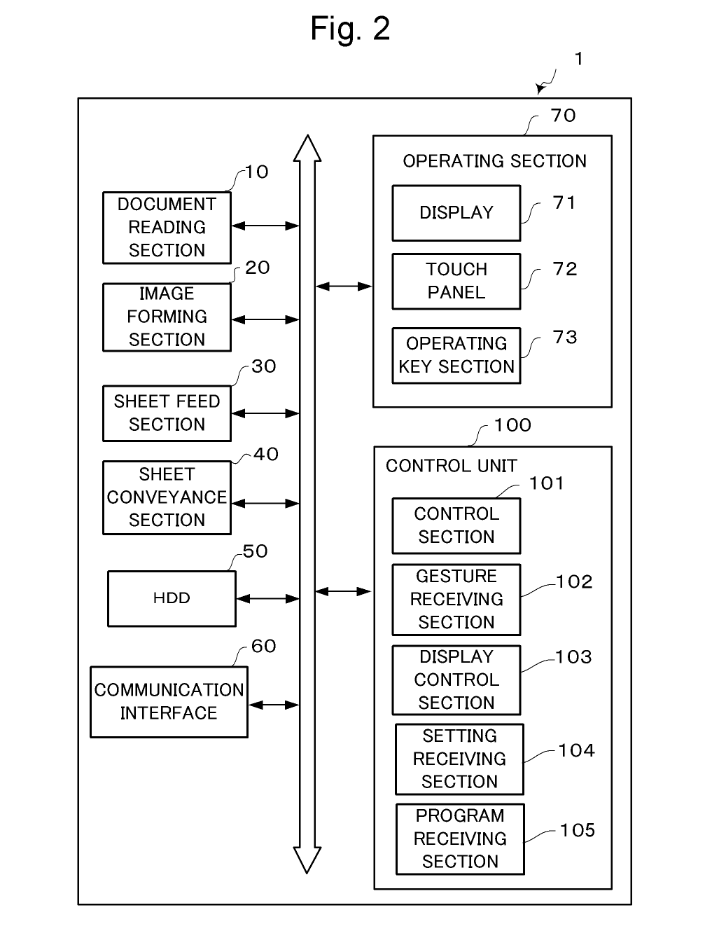

FIG. 1 is a perspective view showing the appearance of an image forming apparatus as an example of a display input apparatus according to Embodiment 1 of the present disclosure. FIG. 2 is a functional block diagram showing an essential internal configuration of the image forming apparatus as an example of the display input apparatus according to Embodiment 1 of the present disclosure.

The image forming apparatus 1 is a multifunction peripheral having multiple functions including, for example, a copy function, a print function, a scan function, and a facsimile function. As shown in FIG. 1, the image forming apparatus 1 is roughly composed of an apparatus body 2, a document reading section 10 disposed above the apparatus body 2, and a connecting portion 3 provided between the document reading section 10 and the apparatus body 2.

In a document reading operation of the image forming apparatus 1, the document reading section 10 optically reads an original document being fed from a document feed section 4 or an original document placed on an unshown original glass plate to generate image data. The image data generated by the document reading section 10 is stored on an internal HDD, a network-connected computer or the like.

In an image forming operation of the image forming apparatus 1, an image forming section 20 forms a toner image on an unshown photosensitive drum through charging, exposure, and developing processes based on image data generated by the document reading operation or image data stored on the internal HDD. A paper sheet fed from a sheet feed section 30 is conveyed, along a sheet conveyance path formed inside the image forming apparatus 1, by a sheet conveyance section 40 and the toner image is transferred to the paper sheet at a predetermined location in the interior of the image forming apparatus 1. Thereafter, the paper sheet is subjected to fixation processing and then discharged to a sheet output tray 5.

The image forming apparatus 1 includes, in addition to the aforementioned document reading section 10, image forming section 20, sheet feed section 30, and sheet conveyance section 40, an HDD 50, a communication interface 60, an operating section 70, a control unit 100, and so on.

The HDD 50 is a large storage device and can store image data read by the document reading section 10 and changed settings received by a hereinafter described setting receiving section 104 of the control unit 100.

The communication interface 60 includes a communication module, such as a LAN chip, and is configured to provide data communication with other image forming apparatuses, personal computers and so on connected via a network.

The operating section 70 includes a display 71, a touch panel 72, and an operating key section 73.

The display 71 is formed of a liquid crystal display (LCD) or an organic light-emitting diode (OLED) display. The display 71 is configured to display, under the control of a hereinafter described display control section 103 of the control unit 100, a setting item list composed of a plurality of setting items lined up therein, a setting candidate list composed of setting candidates lined up for a changeable setting, and so on.

The touch panel 72 is a touch panel of, for example, a so-called resistive film system or a capacitance system. The touch panel 72 is disposed in front of the display 71 and configured to detect a user's touch of the display screen of the display 71 together with the point of touch. When detecting the user's touch, the touch panel 72 outputs a detection signal indicating a coordinate point of the point of touch to a hereinafter described gesture receiving section 102 and so on of the control unit 100. The touch panel 72 encompasses a touch panel operable to detect a user's finger or the like when the user's finger or the like, even if not directly touching the display screen, comes within a certain small distance of the display screen. Therefore, the term “touch” used in this embodiment includes a state where a finger or the like coming within the certain small distance of the display screen is detected, without a direct touch of the display screen, by the function of the touch panel 72, with the consideration of this state as a substantial touch.

The operating key section 73 includes, for example, a menu key for calling up a menu, arrow keys for moving the focus of a GUI forming the menu, a determination key for performing a determination operation for the GUI forming the menu, numerical keys, and so on and is configured to receive various user's operations for a setting menu displayed on the display 71.

The control unit 100 is composed of a CPU (central processing unit), a RAM (random access memory), a ROM (read only memory), and so on. When a display input control program stored in the above ROM or on the HDD 50 is executed by the above CPU, the control unit 100 functions as a control section 101, the gesture receiving section 102, the display control section 103, the setting receiving section 104, and a program receiving section 105. Alternatively, each of the control section 101, the gesture receiving section 102, the display control section 103, the setting receiving section 104, and the program receiving section 105 of the control unit 100 may not be implemented by the operation of the control unit 100 in accordance with the display input control program but may be constituted by a hardware circuit.

The control section 101 governs the overall operation control of the image forming apparatus 1. For example, the control section 101 controls, based on the settings or program stored on the HDD 50, the image forming section 20, the sheet feed section 30, the sheet conveyance section 40, and so on to allow the formation of a user's desired image on a paper sheet.

The gesture receiving section 102 is configured to identify, based on the detection signal output from the touch panel 72, a user's gesture input by the user. Then, the gesture receiving section 102 receives the identified user's gesture and outputs a control signal corresponding to the user's gesture to the display control section 103, the setting receiving section 104, the program receiving section 105, and so on.

The term user's gesture herein includes a scroll gesture (referred to also as a swipe gesture), a touch gesture, and a pinch gesture. For example, when the user slides his/her finger on the display screen while keeping it in touch with the touch panel 72, the touch panel 72 outputs to the gesture receiving section 102 detection signals indicating a series of points of movement from an initial point at which the touch has been first detected to a last point at which the touch is last detected. Based on the detection signals output from the touch panel 72, the gesture receiving section 102 identifies the user's gesture input by the user as a scroll gesture. Then, the gesture receiving section 102 outputs a control signal corresponding to the scroll gesture to the display control section 103, the setting receiving section 104, the program receiving section 105, and so on.

The display control section 103 has the function of controlling the display operation of the display 71 according to the user's gesture received by the gesture receiving section 102. For example, when the gesture receiving section 102 receives a scroll gesture, the display control section 103 allows, according to the scroll gesture, the display 71 to provide a scrolling display of an image displayed thereon.

The image forming apparatus 1 has a program entry mode in which a program consisting of a combination of settings of a plurality of setting items is received. In the program entry mode, the display control section 103 allows the display 71 to display a predetermined setting screen.

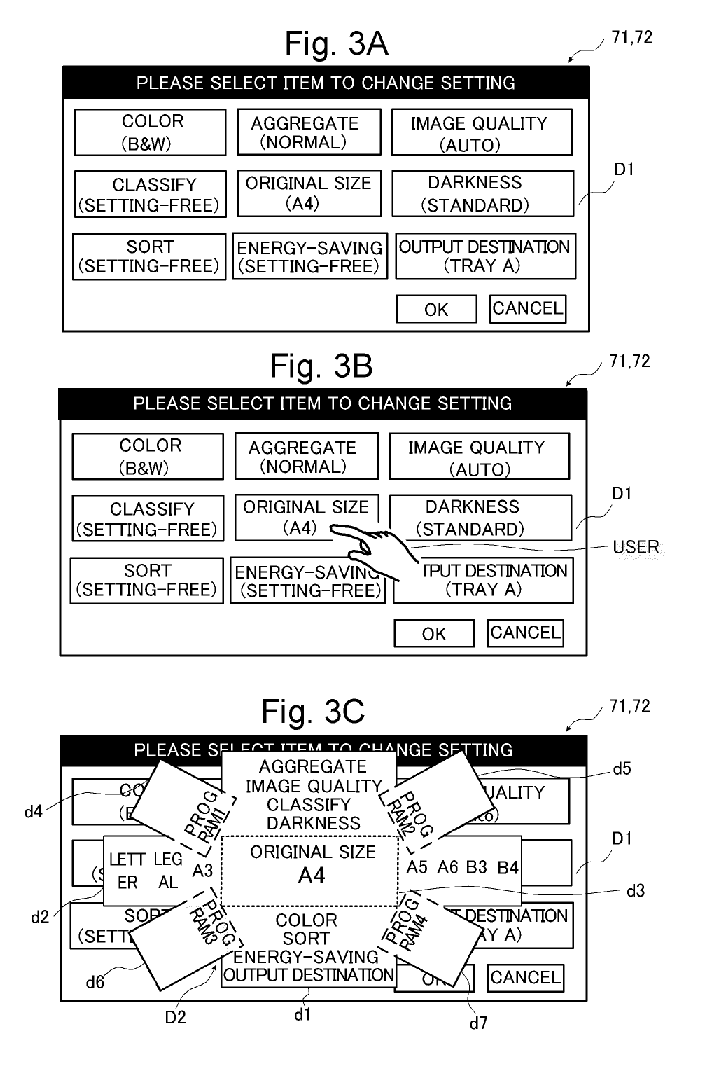

FIGS. 3A to 3C show display examples of a setting screen displayed on the display 71 of the image forming apparatus 1 according to Embodiment 1 of the present disclosure. As shown in FIG. 3A, the display control section 103 allows the display 71 to display a setting screen D1 presenting a table of a plurality of setting items whose settings can be changed on the image forming apparatus 1. In the example shown in FIG. 3A, the current settings of the setting items are presented together with their setting items.

When, as shown in FIG. 3B, the gesture receiving section 102 receives a selection of one of the plurality of setting items via a touch gesture, the display control section 103 allows the display 71 to user-visibly display, in the center of the display 71, a setting window D2 for the selected setting item by overlaying the setting window D2 on the setting screen D1 (see FIG. 3C). In this case, the setting window D2 is formed by arranging a setting item list d1 composed of a plurality of setting items lined up in a first direction (vertical direction in the example shown in FIG. 3C) and a setting candidate list d2 composed of a plurality of setting candidates listed for the selected one of the plurality of setting items and lined up in a second direction (horizontal direction in the example shown in FIG. 3C) different from the first direction, one list across the other. The setting window D2 is further provided with program entry regions d4, d5, d6, d7 adjoining an intersecting region d3 of the setting item list d1 and the setting candidate list d2 on the display 71 and extending in third directions (oblique directions in the example shown in FIG. 3C) different from the first and second directions. As will be described in detail hereinafter, when the user performs a scroll gesture (swipe gesture) starting at one of the setting candidates presented in the setting candidate list d2 and moving to any program entry region d4, d5, d6, d7, the image forming apparatus 1 receives the one setting candidate as a setting forming part of a program. Furthermore, the image forming apparatus 1 is configured to allow the display 71 to provide, with the setting window D2 displayed, respective scrolling displays of the setting item list d1 and the setting candidate list d2 according to their respective scroll gestures received by the gesture receiving section 102.

The program receiving section 105 is configured to receive a program consisting of a combination of settings of a plurality of setting items according to a user's gesture received by the gesture receiving section 102. Furthermore, the program receiving section 105 allows the HDD 50 to save the received program.

The setting receiving section 104 is configured to receive a change of the setting of each setting item according to a user's gesture received by the gesture receiving section 102 and allows the HDD 50 to save the changed setting.

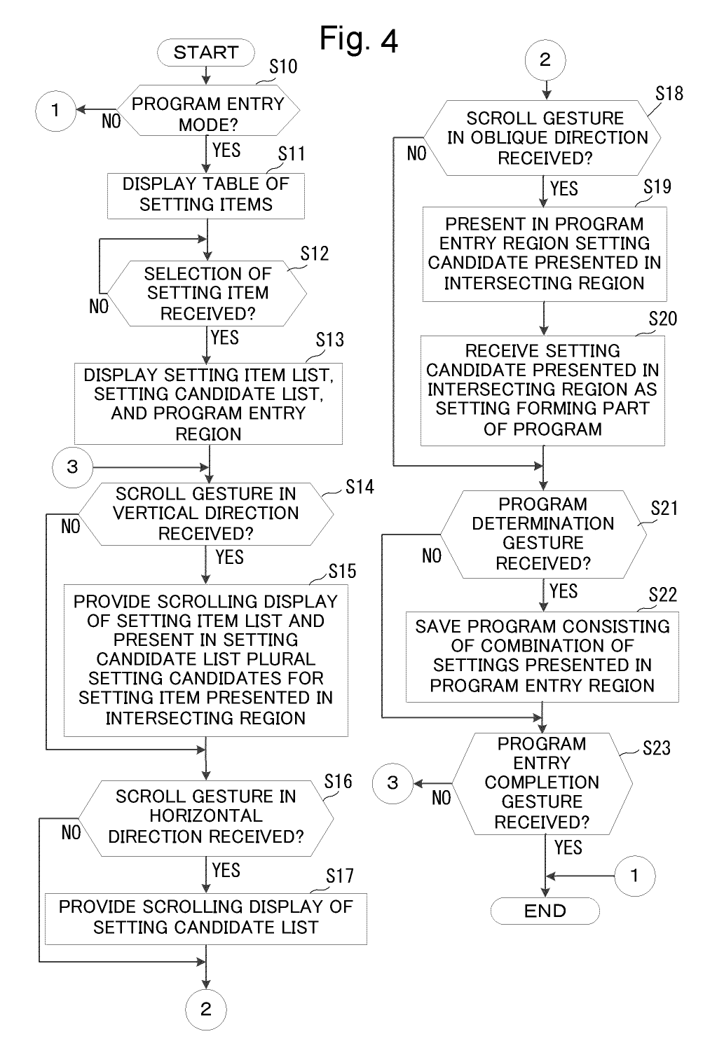

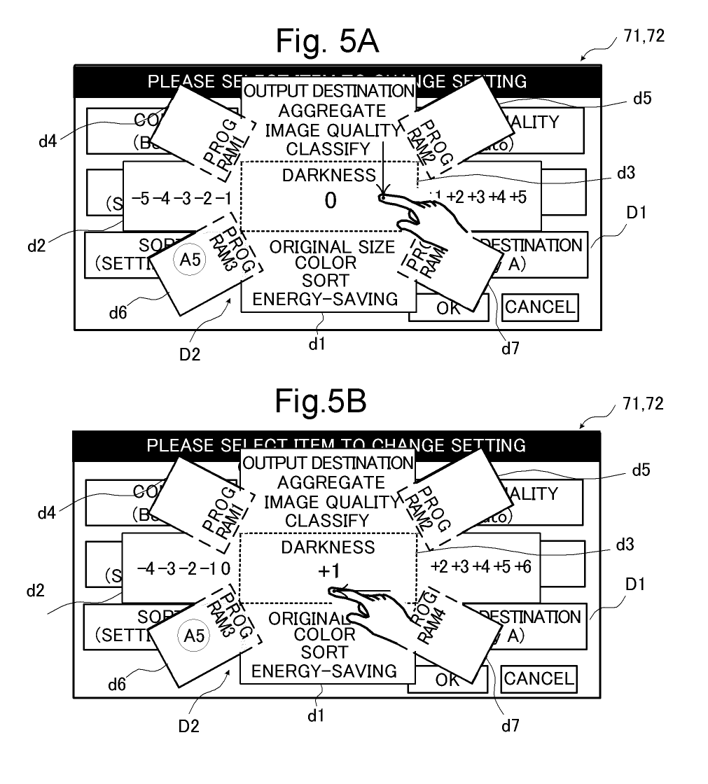

Next, a description will be given of the operation of the image forming apparatus 1 having the aforementioned configuration. FIG. 4 is a flowchart showing a processing flow of the image forming apparatus 1 according to Embodiment 1 of the present disclosure. FIGS. 5A, 5B, 6A, 6B, and 7A to 7C show other display examples of the setting screen displayed on the display 71 of the image forming apparatus 1 according to Embodiment 1 of the present disclosure.

The control section 101 of the image forming apparatus 1 first determines whether or not the image forming apparatus 1 transitions to a program entry mode in which a program consisting of a combination of settings of a plurality of setting items is received (step S10). If a button for transition to the program entry mode is presented on the display 71, the image forming apparatus 1 can transition to the program entry mode when the gesture receiving section 102 receives a touch gesture consisting of a touch of the location on the touch panel 72 just above the button presented. Alternatively, if a dedicated key for calling up the program entry mode is provided in the operating key section 73, the image forming apparatus 1 can transition to the program entry mode at the push of the dedicated key.

Upon transition to the program entry mode (YES in step S10), as shown in FIG. 3A, the display control section 103 allows the display 71 to display the setting screen D1 presenting a table of a plurality of setting items whose settings can be changed on the image forming apparatus 1 (step S11).

Then, the display control section 103 determines, with the setting screen D1 displayed, whether or not the gesture receiving section 102 has received a selection of one of the plurality of setting items via a touch gesture (step S12).

If a selection of one setting item has been received (YES in step S12), the display control section 103 allows the display 71 to user-visibly display a setting window D2 for the selected setting item by overlaying the setting window D2 on the setting screen D1 (step S13). At this time, the display control section 103 allows the display 71 to display four program entry regions d4, d5, d6, d7 adjoining the intersecting region d3 of the setting item list d1 and the setting candidate list d2 and extending in third directions different from the first and second directions. Furthermore, the display control section 103 allows the display 71 to present, in the intersecting region d3 of the setting item list d1 and the setting candidate list d2, the setting item the selection of which has been received in step S12. Moreover, the display control section 103 allows the display 71 to present, in the setting candidate list d2, a plurality of setting candidates for the setting item presented in the intersecting region d3. Since, in the example shown in FIGS. 3B and 3C, “ORIGINAL SIZE” is selected as the setting item, a plurality of candidates, such as “A3”, “A4”, and “B3”, for the changeable setting of the setting item “ORIGINAL SIZE” are presented in the setting candidate list d2. In addition, “A4”, which is the current setting of the setting item “ORIGINAL SIZE”, is presented in the intersecting region d3.

Then, the display control section 103 determines, with the setting window D2 displayed, whether or not the gesture receiving section 102 has received a scroll gesture in a vertical direction (step S14).

If the scroll gesture in the vertical direction has been received (YES in step S14), the display control section 103 allows the display 71 to provide a scrolling display of the setting item list d1 and present, in the setting candidate list d2, a plurality of setting candidates for the setting item presented in the intersecting region d3 of the setting item list d1 and the setting candidate list d2 by the scrolling display (step S15). In the example shown in FIG. 5A, a scroll gesture in a vertical direction from the state shown in FIG. 3C has been received and a scrolling display of the setting item list d1 is thus provided, so that the setting item “DARKNESS” is presented in the intersecting region d3. In this case, the setting candidates presented in the setting candidate list d2 are changed from those for the setting item “ORIGINAL SIZE” to those for the setting item “DARKNESS”.

Furthermore, the display control section 103 determines, with the setting window D2 displayed, whether or not the gesture receiving section 102 has received a scroll gesture in a horizontal direction (step S16).

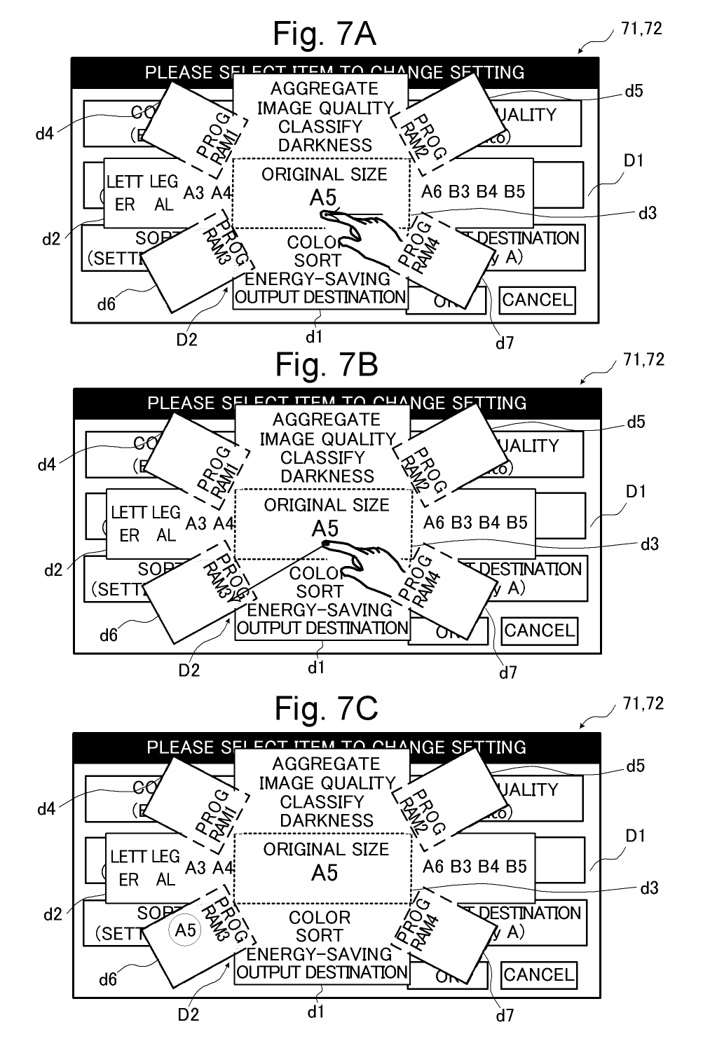

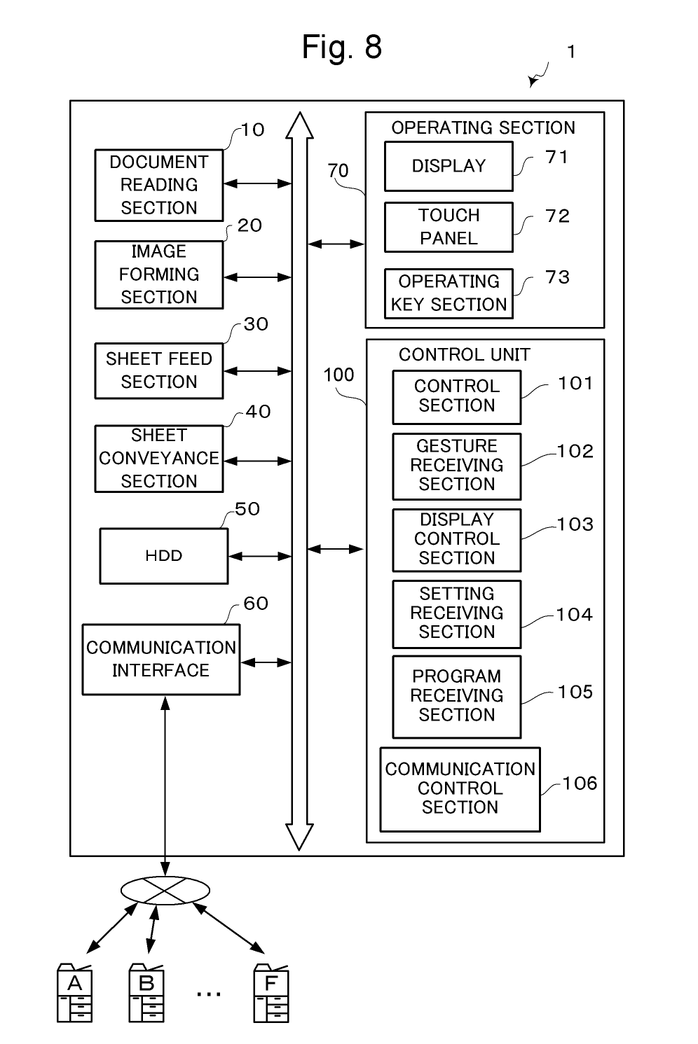

If the scroll gesture in the horizontal direction has been received (YES in step S16), the display control section 103 allows the display 71 to provide a scrolling display of the setting candidate list d2 (step S17). In the example shown in FIG. 5B, a scroll gesture in a horizontal direction from the state shown in FIG. 5A has been received and a scrolling display of the setting candidate list d2 is thus provided, so that “+1” is presented as a setting candidate for the setting item “DARKNESS” in the intersecting region d3 of the setting item list d1 and the setting candidate list d2. In the example shown in FIG. 7A, a scroll gesture in a horizontal direction from the state shown in FIG. 3C has been received and a scrolling display of the setting candidate list d2 is thus provided, so that “A5” is presented as a setting candidate for the setting item “ORIGINAL SIZE” in the intersecting region d3 of the setting item list d1 and the setting candidate list d2.

Furthermore, during the scrolling display of the setting item list d1 or the setting candidate list d2, the display control section 103 allows the display 71 to cyclically display setting items or setting candidates. In the example shown in FIG. 3C, the setting item “AGGREGATE” is presented at the top of the setting item list d1 and the setting item “OUTPUT DESTINATION” is presented at the bottom of the setting item list d1. Then, upon receipt of a scroll gesture in a vertical direction from the above state, the setting items of the setting item list d1 are cyclically displayed, so that as shown in FIG. 5A the setting item “OUTPUT DESTINATION” is presented at the top of the setting item list d1.

Moreover, the display control section 103 determines, with the setting window D2 displayed, whether or not the gesture receiving section 102 has received a scroll gesture (swipe gesture) in an oblique direction (step S18). Specifically, the display control section 103 determines whether or not the gesture receiving section 102 has received a scroll gesture (swipe gesture) moving from the intersecting region d3 of the setting item list d1 and the setting candidate list d2 to any program entry region d4, d5, d6, d7.

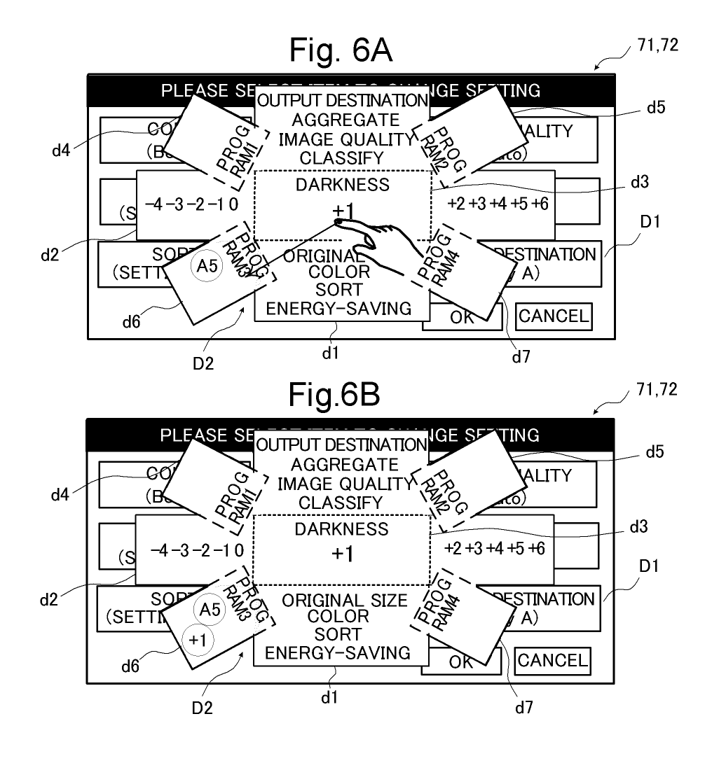

If the gesture receiving section 102 has received the scroll gesture in the oblique direction (YES in step S18), the display control section 103 allows the display 71 to present, in the relevant program entry region d4, d5, d6 or d7 which is the destination for swipe, the setting candidate presented in the intersecting region d3 (step S19). In the example shown in FIG. 6A, “+1” is presented as a setting candidate for the setting item “DARKNESS” in the intersecting region d3. If at this time the user inputs a scroll gesture in an obliquely downward left direction from the intersecting region d3 to the program entry region d6, the setting candidate “+1” presented in the intersecting region d3 is also presented in the program entry region d6 (see FIG. 6B). In the example shown in FIG. 7B, “A5” is presented as a setting candidate for the setting item “ORIGINAL SIZE” in the intersecting region d3. If at this time the user inputs a scroll gesture in an obliquely downward left direction from the intersecting region d3 to the program entry region d6, the setting candidate “A5” presented in the intersecting region d3 is also presented in the program entry region d6 (see FIG. 7C).

Furthermore, if the gesture receiving section 102 has received the scroll gesture in the oblique direction (YES in step S18), the program receiving section 105 receives, as a setting forming part of a program, the setting candidate presented in the intersecting region d3 (step S20). In the example shown in FIG. 6B, a scroll gesture in an obliquely downward left direction from the intersecting region d3 to the program entry region d6 is performed by the user. In this case, the program receiving section 105 receives, as a setting forming part of Program 3, the setting candidate “+1” presented in the intersecting region d3. In the example shown in FIG. 7C, the program receiving section 105 receives, as a setting forming part of Program 3, the setting candidate “A5” presented in the intersecting region d3.

Then, the display control section 103 determines whether or not the gesture receiving section 102 has received a predetermined program determination gesture (step S21). The predetermined program determination gesture is, for example, a gesture of two touches of the relevant program entry region d4, d5, d6, d7 of the touch panel 72 within a predetermined period of time (a double-touch gesture).

If the program determination gesture has been received (YES in step S21), the program receiving section 105 allows the HDD 50 to save a program consisting of a combination of settings presented in the relevant program entry region d4, d5, d6, d7 (step S22). In the example shown in FIG. 6B, when the user inputs a gesture of a double-touch of the program entry region d6, the program receiving section 105 allows the HDD 50 to save a program consisting of the setting “+1” of the setting item “DARKNESS” and the setting “A5” of the setting item “ORIGINAL SIZE”.

The control section 101 may be configured to execute, when the gesture receiving section 102 receives a predetermined program execution gesture, program execution processing based on the settings presented in the relevant program entry region d4, d5, d6, d7. The predetermined program execution gesture is, for example, a gesture of a continuous touch of the relevant program entry region d4, d5, d6, d7 of the touch panel 72 for a predetermined period of time or more. In the example shown in FIG. 6B, when the aforementioned program execution gesture is input by the user, the control section 101 controls the image forming section 20, the sheet feed section 30, and so on under the conditions of the setting “+1” of the setting item “DARKNESS” and the setting “A5” of the setting item “ORIGINAL SIZE” to form an image on a paper sheet.

After the processing in step S22, the display control section 103 determines whether or not the gesture receiving section 102 has received a predetermined program entry completion gesture (step S23). The predetermined program entry completion gesture is, for example, a gesture of a touch anywhere on a region of the touch panel 72 outside the setting window D2.

If no program entry completion gesture has been received (NO in step S23), the process returns to step S14. On the other hand, if a program entry completion gesture has been received (YES in step S23), the program entry processing ends.

As thus far described, the display input apparatus according to Embodiment 1 of the present disclosure includes the display 71, the touch panel 72 disposed in front of the display 71, the gesture receiving section 102 configured to receive a user's gesture on the touch panel 72, the display control section 103 configured to control the display operation of the display 71 according to a user's gesture received by the gesture receiving section 102, and the program receiving section 105 configured to receive a program consisting of a combination of settings of a plurality of setting items according to a user's gesture received by the gesture receiving section 102. Furthermore, the display control section 103 allows the display 71 to display the setting item list d1 composed of a plurality of setting items lined up in a first direction and the setting candidate list d2 composed of a plurality of setting candidates listed for one of the plurality of setting items and lined up in a second direction different from the first direction, with the setting item list d1 and the setting candidate list d2 across each other. The display control section 103 allows, when the gesture receiving section 102 receives a scroll gesture in the first direction, the display 71 to provide a scrolling display of the setting item list d1 and present, in the setting candidate list d2, a plurality of setting candidates for the setting item presented in the intersecting region d3 of the setting item list d1 and the setting candidate list d2 by the scrolling display and allows, when the gesture receiving section 102 receives a scroll gesture in the second direction, the display 71 to provide a scrolling display of the setting candidate list d2. When the gesture receiving section 102 receives a scroll gesture moving from the intersecting region d3 to the predetermined program entry region d4, d5, d6, d7 on the display 71, the program receiving section 105 receives, as a setting forming part of a program, the setting candidate presented in the intersecting region d3.

In configuring a program, it is necessary to select the settings of a plurality of setting items. However, if in general display input apparatuses a selection of the setting of one setting item is followed by a selection of the setting of a second setting item, the display must return to and display an initial setting item select screen and then the desired second setting item must be selected on the setting item select screen. In order to configure a program, it is necessary to move back and forth between the setting item select screen and the setting change screen, which is operationally troublesome and user-unfriendly.

In contrast, in the display input apparatus according to Embodiment 1 of the present disclosure, the selection of the settings of a plurality of setting items can be received on a single setting screen. In configuring a program, there is no need to move back and forth between a setting item select screen and a setting change screen and the settings of a plurality of setting items can be selected on the same setting screen, which is highly user-friendly. Furthermore, the user can configure a program simply by determining the settings of a plurality of setting items via scroll gestures in two directions and then performing a scroll gesture moving to the predetermined program entry region. The manipulation required for the user to configure a program is only such intuitive manipulation as described just above and therefore a program can be configured with simpler manipulation than before.

### Embodiment 2

FIG. 8 is a functional block diagram showing an essential internal configuration of an image forming apparatus as an example of a display input apparatus according to Embodiment 2 of the present disclosure.

A control unit 100 of an image forming apparatus 1 according to Embodiment 2 of the present disclosure functions not only as the aforementioned sections described in Embodiment 1 but also as a communication control section 106 when a display input control program stored in its internal ROM or on an HDD 50 is executed by its internal CPU. The communication control section 106 is configured to control a communication interface 60 to provide data communication with pieces of electronic equipment connected via a network, such as other image forming apparatuses and personal computers. In the example shown in FIG. 8, the communication interface 60 is connected for communication via the Internet with six image forming apparatuses A to F. The communication control section 106 can transmit, via the communication interface 60 to the image forming apparatuses A to F, settings configured in the image forming apparatus 1, commands to execute image formation based on the settings, and so on.

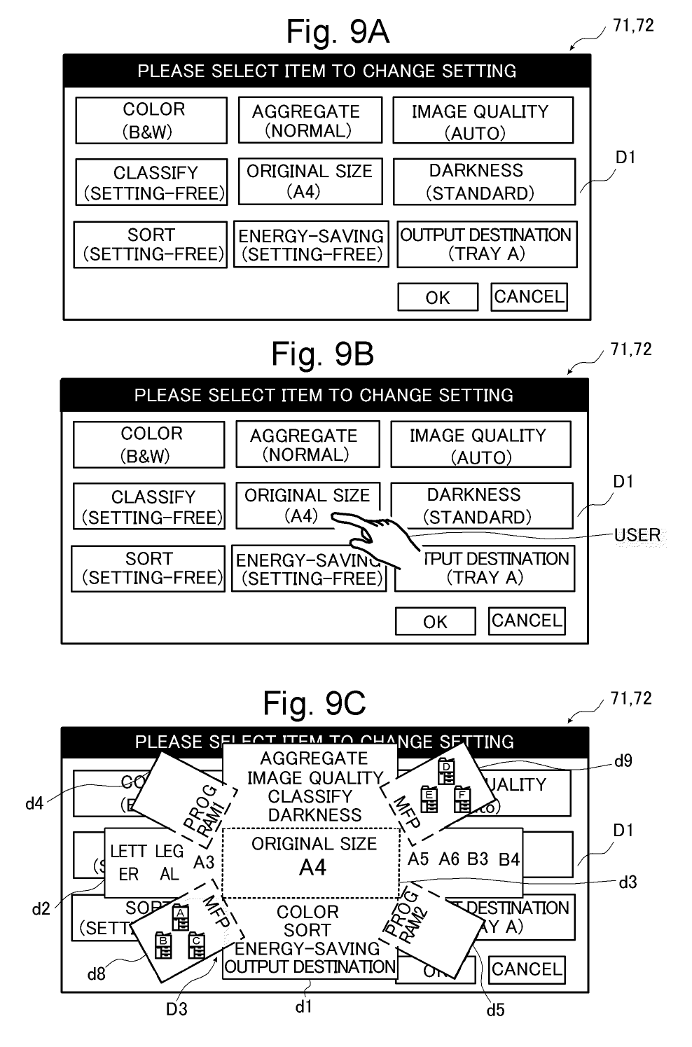

FIGS. 9A to 9C show display examples of a setting screen displayed on a display 71 of the image forming apparatus 1 according to Embodiment 2 of the present disclosure.

FIGS. 9A and 9B show the same setting screen D1 as displayed on the display 71 of the image forming apparatus 1 according to Embodiment 1 shown in FIGS. 3A and 3B. When, as shown in FIG. 9B, the gesture receiving section 102 receives a selection of one of the plurality of setting items via a touch gesture, the display control section 103 allows the display 71 to user-visibly display, in the center of the display 71, a setting window D3 for the selected setting item by overlaying the setting window D3 on the setting screen D1 (see FIG. 9C).

The setting screen D3 is provided with transmission target regions d8, d9 adjoining the intersecting region d3 of the setting item list d1 and the setting candidate list d2 and extending in third directions (obliquely downward left and obliquely upward right directions in the example shown in FIG. 9C) different from the first and second directions. The transmission target regions d8, d9 present respective icons of the six image forming apparatuses A to F connected via the Internet to the image forming apparatus 1. As will be described in detail hereinafter, when the user performs a scroll gesture (swipe gesture) starting at one of the setting candidates presented in the setting candidate list d2 and moving to the icon of any image forming apparatus A to F presented in the transmission target regions d8, d9, the image forming apparatus 1 transmits to the corresponding image forming apparatus A to F a command to store the one setting candidate as a setting, a command to execute image formation based on the one setting candidate as a setting, or the like.

The setting screen D3 is further provided with program entry regions d4, d5 adjoining the intersecting region d3 of the setting item list d1 and the setting candidate list d2 and extending in fourth directions (obliquely upward left and obliquely downward right directions in the example shown in FIG. 9C) different from the first, second, and third directions. As will be described in detail hereinafter, when the user performs a scroll gesture (swipe gesture) starting at one of the setting candidates presented in the setting candidate list d2 and moving to any program entry region d4, d5, the image forming apparatus 1 receives the one setting candidate as a setting forming part of a program.

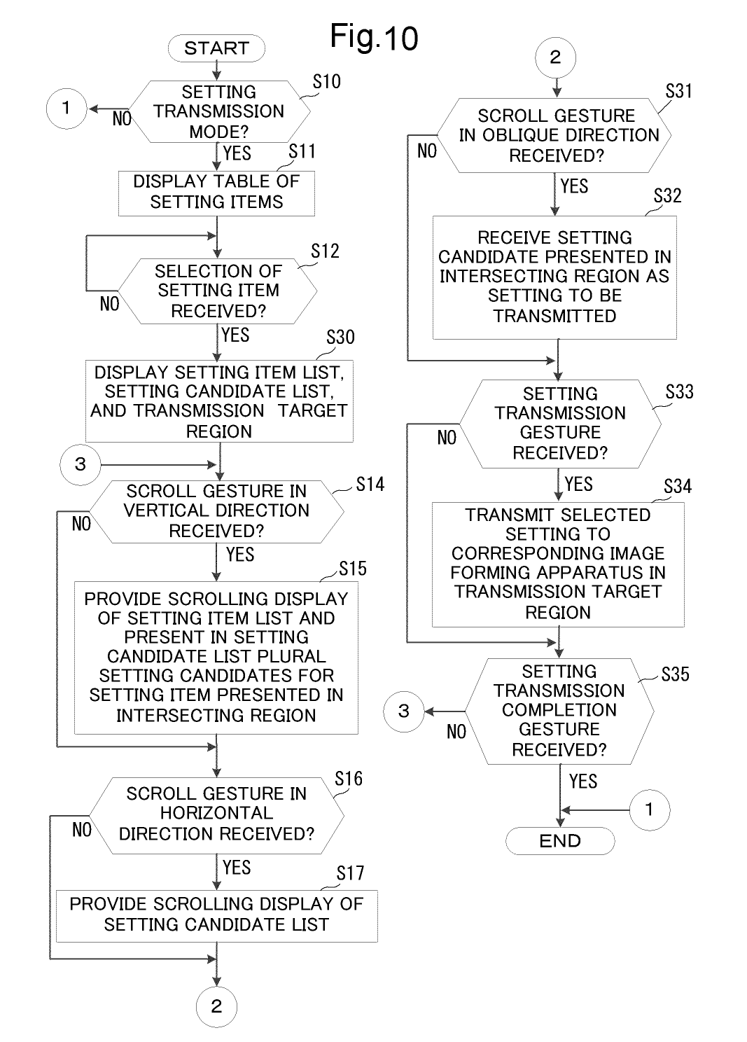

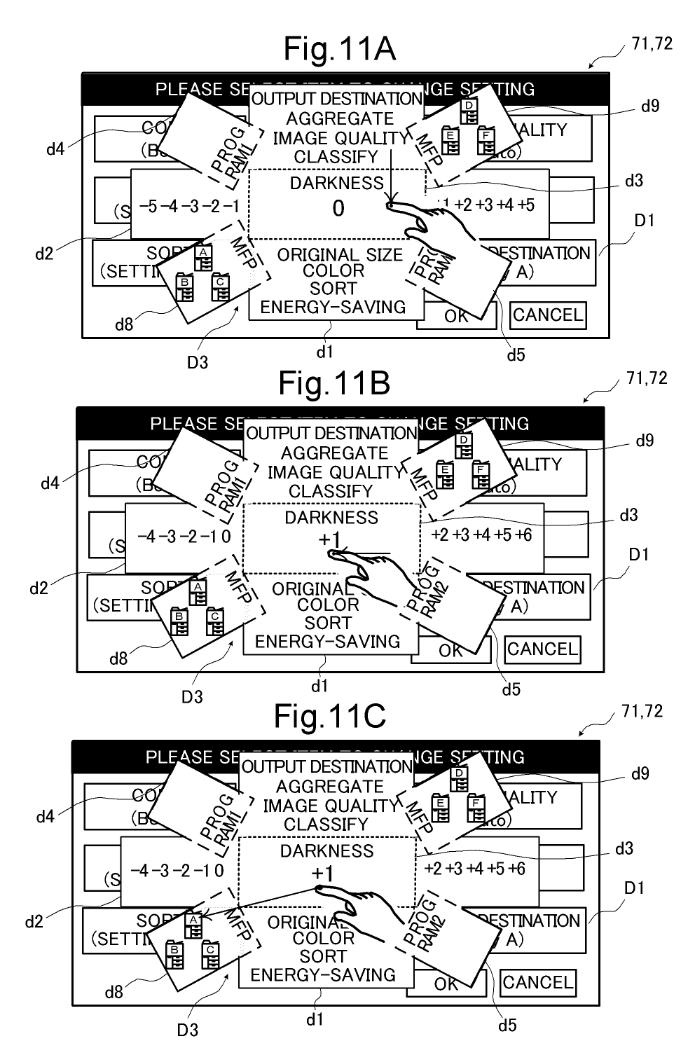

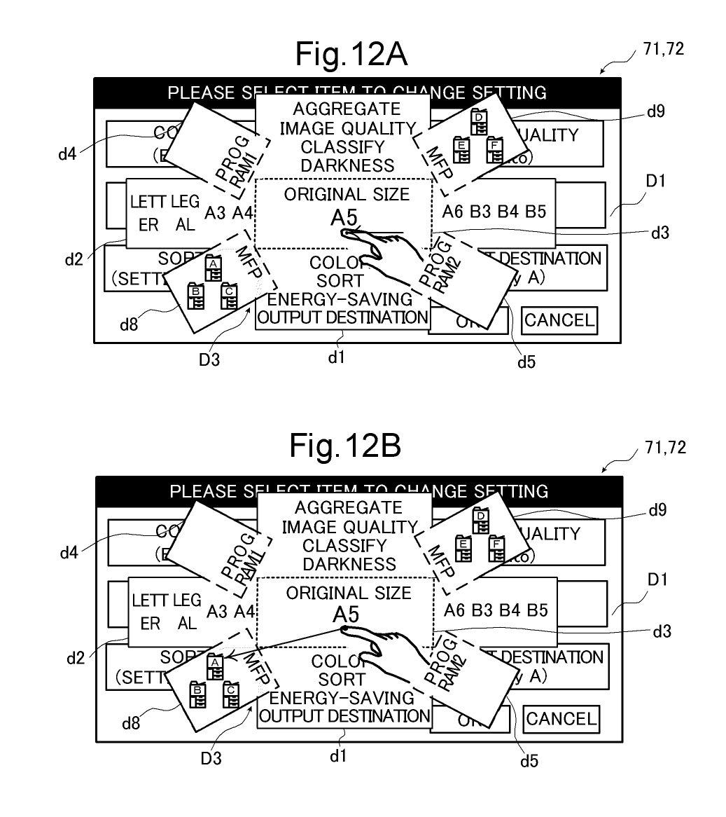

FIG. 10 is a flowchart showing a processing flow of the image forming apparatus 1 according to Embodiment 2 of the present disclosure. The same pieces of processing as those illustrated in the flowchart of FIG. 4 are designated by the same references and further explanation thereof will be omitted. FIGS. 11A to 11C, 12A, and 12B show other display examples of the setting screen displayed on the display 71 of the image forming apparatus 1 according to Embodiment 2 of the present disclosure.

If the gesture receiving section 102 has received a selection of one setting item (YES in step S 12), the display control section 103 allows the display 71 to user-visibly display a setting window D3 for the selected setting item by overlaying the setting window D3 on the setting screen D1 (step S30). At this time, the display control section 103 allows the display 71 to display the transmission target regions d8, d9 adjoining the intersecting region d3 of the setting item list d1 and the setting candidate list d2 and extending in third directions different from the first and second directions.

Furthermore, the display control section 103 allows the display 71 to present, in the intersecting region d3 of the setting item list d1 and the setting candidate list d2, the setting item the selection of which has been received in step S12. Moreover, the display control section 103 allows the display 71 to present, in the setting candidate list d2, a plurality of setting candidates for the setting item presented in the intersecting region d3. Since, in the example shown in FIGS. 9B and 9C, “ORIGINAL SIZE” is selected as the setting item, a plurality of setting candidates, such as “A3”, “A4”, and “B3”, for the changeable setting of the setting item “ORIGINAL SIZE” are presented in the setting candidate list d2. In addition, “A4”, which is the current setting of the setting item “ORIGINAL SIZE”, is presented in the intersecting region d3.

The display control section 103 determines, with the setting window D3 displayed, whether or not the gesture receiving section 102 has received a scroll gesture (swipe gesture) in an oblique direction (step S31). Specifically, the display control section 103 determines whether or not the gesture receiving section 102 has received a scroll gesture (swipe gesture) moving from the intersecting region d3 of the setting item list d1 and the setting candidate list d2 to any transmission target region d8, d9.

If the gesture receiving section 102 has received the scroll gesture in the oblique direction (YES in step S31), the setting receiving section 104 receives, as a setting to be transmitted, the setting candidate presented in the intersecting region d3 (step S32). In the example shown in FIGS. 11A to 11C, a scroll gesture in an obliquely downward left direction from the intersecting region d3 to the icon of the image forming apparatus A in the transmission target region d8 is performed by the user. In this case, the setting receiving section 104 receives, as a setting to be transmitted to the image forming apparatus A, the setting candidate “+1” presented in the intersecting region d3. In the example shown in FIGS. 12A and 12B, the setting receiving section 104 receives, as a setting to be transmitted to the image forming apparatus A, the setting candidate “A5” presented in the intersecting region d3.

The display control section 103 may be configured to allow, when the gesture receiving section 102 receives a scroll gesture in an oblique direction, the display 71 to present, in the relevant transmission target region d8 or d9, the setting candidate presented in the intersecting region d3.

Then, the display control section 103 determines whether or not the gesture receiving section 102 has received a predetermined setting transmission gesture (step S33). The predetermined setting transmission gesture is, for example, a gesture of two touches of the relevant transmission target region d8, d9 of the touch panel 72 within a predetermined period of time (a double-touch gesture).

If the setting transmission gesture has been received (YES in step S33), the communication control section 106 allows the communication interface 60 to transmit, to the corresponding image forming apparatus or apparatuses in the relevant transmission target region d8 or d9, the to-be-transmitted setting or settings received by the setting receiving section 104 (step S34). At this time, the communication control section 106 may transmit, together with the setting or settings, a command to store the setting or settings or a command to execute image formation based on the setting or settings. In the example shown in FIG. 11C, when the user inputs a gesture of a double-touch of the icon of the image forming apparatus A in the transmission target region d8, the communication control section 106 allows the communication interface 60 to transmit to the image forming apparatus A the setting “+1” of the setting item “DARKNESS”.

The above description in this embodiment has been given of the case where when the gesture receiving section 102 receives a predetermined setting transmission gesture, the communication control section 106 allows the transmission of the to-be-transmitted setting or settings. However, the present disclosure is not necessarily limited to this case. When the gesture receiving section 102 receives a scroll gesture (swipe gesture) moving from the intersecting region d3 of the setting item list d1 and the setting candidate list d2 to any transmission target region d8 or d9, the communication control section 106 may allow the communication interface 60 to transmit the setting received by the setting receiving section 104.

After the processing in step S34, the display control section 103 determines whether or not the gesture receiving section 102 has received a predetermined setting transmission completion gesture (step S35). The predetermined setting transmission completion gesture is, for example, a gesture of a touch anywhere on a region of the touch panel 72 outside the setting window D3.

If no setting transmission completion gesture has been received (NO in step S35), the process returns to step S14. On the other hand, if a setting transmission completion gesture has been received (YES in step S35), the setting transmission processing ends.

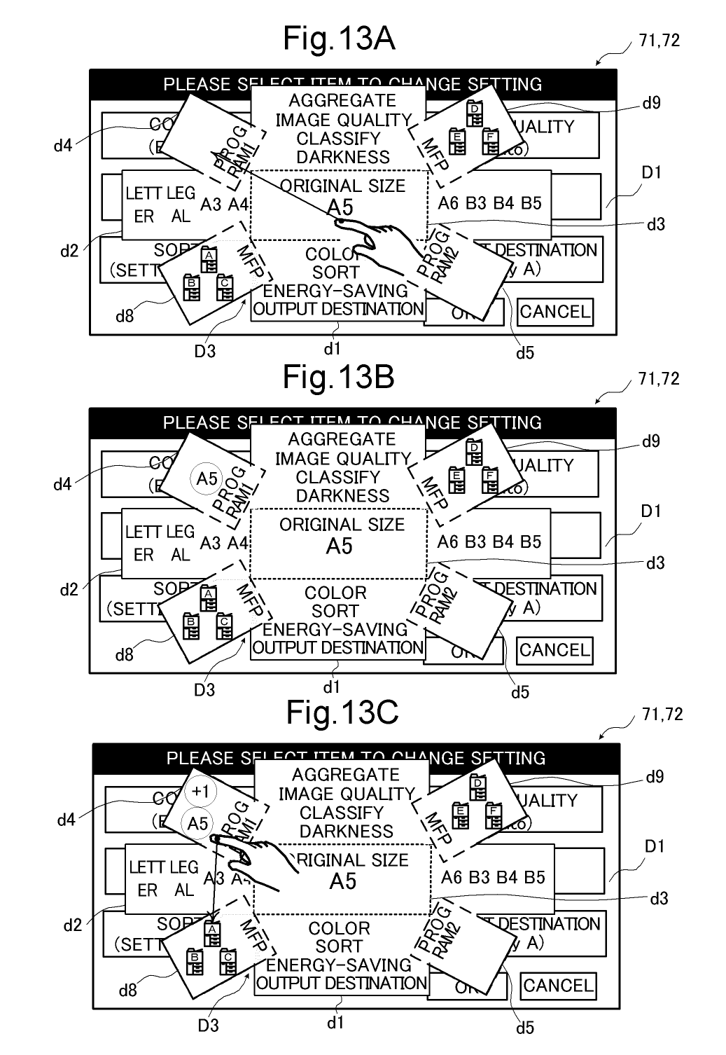

The following is a supplement to the aforementioned setting transmission processing. FIGS. 13A to 13C show other display examples of the setting screen displayed on the display 71 of the image forming apparatus 1 according to Embodiment 2 of the present disclosure.

In the above processing, when the gesture receiving section 102 receives a scroll gesture in a fourth direction, i.e., receives a scroll gesture (swipe gesture) moving from the intersecting region d3 to any program entry region d4 or d5, the display control section 103 allows, like the image forming apparatus 1 according to Embodiment 1, the display 71 to present, in the relevant program entry region d4 or d5, the setting candidate presented in the intersecting region d3 (see FIGS. 13A and 13B).

The program receiving section 105 receives a program consisting of a combination of settings of a plurality of setting items according to a user's gesture received by the gesture receiving section 102. In the example shown in FIG. 13C, the program receiving section 105 receives a program consisting of the setting “+1” of the setting item “DARKNESS” and the setting “A5” of the setting item “ORIGINAL SIZE”. The program receiving section 105 allows the HDD 50 to save the received program.

When the gesture receiving section 102 receives a scroll gesture (swipe gesture) moving from any program entry region d4 or d5 to any transmission target region d8 or d9, the communication control section 106 allows the communication interface 60 to transmit the settings presented in the program to the corresponding image forming apparatus in the relevant transmission target region d8 or d9. In the example shown in FIG. 13C, the communication control section 106 allows the transmission of a program consisting of the setting “+1” of the setting item “DARKNESS” and the setting “A5” of the setting item “ORIGINAL SIZE” to the image forming apparatus A.

As described previously, in the display input apparatus according to Embodiment 2 of the present disclosure, when the gesture receiving section 102 receives a scroll gesture moving from the intersecting region d3 to the predetermined transmission target region d8, d9 on the display 71, the communication control section 106 allows the communication interface 60 to transmit, as a changed setting, the setting candidate presented in the intersecting region d3 to the corresponding piece or pieces of electronic equipment in the transmission target region d8, d9.

According to the above configuration, after determining the settings of a plurality of setting items via scroll gestures in two directions, the user need not select, on an equipment select screen, the piece of external equipment for which the settings are to be transmitted and the user can configure the settings for the piece of external equipment by simply performing a scroll gesture moving to the predetermined transmission target region. The manipulation required for the user for this purpose is only such intuitive manipulation as described just above and therefore the settings of a plurality of setting items for a piece of external equipment connected over a network can be configured with simpler manipulation than before.

The present disclosure is not limited to the configurations of the above embodiments and can be modified in various ways.

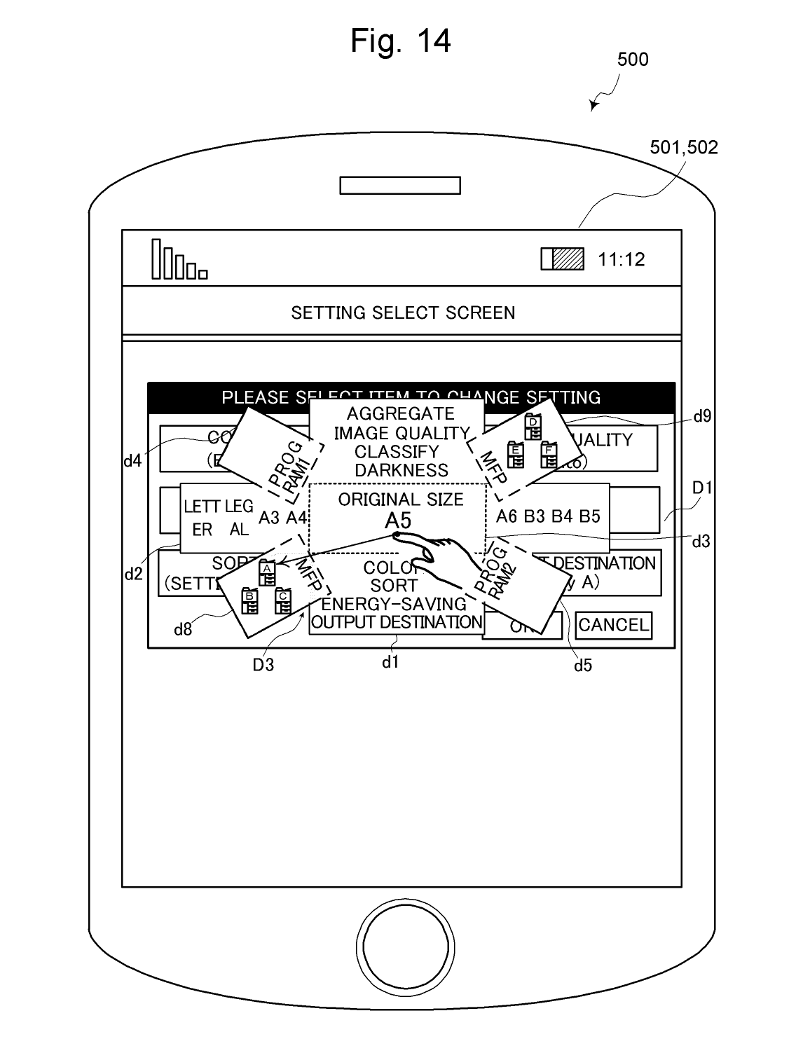

The display input apparatus according to each of the above embodiments of the present disclosure can be built in, besides the image forming apparatus, various pieces of electronic equipment, such as mobile terminals including smartphones, personal computers, and so on. FIG. 14 shows a mobile terminal equipped with the display input apparatus according to one embodiment of the present disclosure. The mobile terminal 500 includes a display 501 and a touch panel 502. The display 501 is configured to be capable of displaying the setting screens D1 and D3. The mobile terminal 500 is configured to be capable of communication with a plurality of image forming apparatuses and transmit, to the image forming apparatuses, settings configured on the mobile terminal 500.

Although in Embodiment 2 the description has been given of the case where two transmission target regions d8, d9 are displayed on the setting screen D3, the present disclosure is not necessarily limited to this. A single transmission target region or three or more transmission target regions may be displayed on the setting screen D3.

Although in Embodiment 1 the description has been given of the case where four program entry regions d4, d5, d6, d7 are displayed on the setting screen D2, the present disclosure is not necessarily limited to this. A single program entry region or five or more program entry regions may be displayed on the setting screen D2.

The display input control program described in the above embodiments may be one stored on a computer-readable non-transitory recording medium, such as a hard disk, a CD-ROM, a DVD-ROM or a semiconductor memory.

Although in the above embodiments the image forming apparatus has been taken as an example of the display input apparatus, the present disclosure is not necessarily limited to this. The display input apparatus applicable as one embodiment of the present disclosure may be, besides the image forming apparatus, for example, a mobile terminal, such as a tablet terminal or a smartphone, a personal computer or a television set.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. A display input apparatus comprising:
a display;
a touch panel disposed in front of the display;
a gesture receiving section configured to receive a user's gesture on the touch panel;
a display control section configured to control a display operation of the display according to a user's gesture received by the gesture receiving section; and
a program receiving section configured to receive a program consisting of a combination of settings of a plurality of setting items according to a user's gesture received by the gesture receiving section,
wherein the display control section allows the display to display a setting item list composed of the plurality of setting items lined up in a first direction and a setting candidate list composed of a plurality of setting candidates listed for one of the plurality of setting items and lined up in a second direction different from the first direction, with the setting item list and the setting candidate list across each other, allows, when the gesture receiving section receives a scroll gesture in the first direction, the display to provide a scrolling display of the setting item list and display the setting candidate list composed of a plurality of setting candidates for the setting item presented in an intersecting region of the setting item list and the setting candidate list by the scrolling display, and allows, when the gesture receiving section receives a scroll gesture in the second direction, the display to provide a scrolling display of the setting candidate list, and
wherein when the gesture receiving section receives a scroll gesture moving from the intersecting region to a predetermined program entry region on the display, the program receiving section receives, as a setting forming part of the program, the setting candidate presented in the intersecting region.

2. The display input apparatus according to claim 1, further comprising:
a communication section capable of communication with pieces of electronic equipment connected over a network; and
a communication control section configured to control data communication of the communication section,
wherein when the gesture receiving section receives a scroll gesture moving from the intersecting region to a predetermined transmission target region on the display, the communication control section allows the communication section to transmit, as a changed setting, the setting candidate presented in the intersecting region to the corresponding piece or pieces of electronic equipment in the transmission target region.

3. The display input apparatus according to claim 2, wherein when the gesture receiving section receives a scroll gesture moving from the program entry region to the transmission target region, the communication control section allows the communication section to transmit the settings presented in the program to the corresponding piece or pieces of electronic equipment in the transmission target region.

4. The display input apparatus according to claim 1, wherein the display control section is configured to allow the display to display the program entry region adjoining the intersecting region and extending in a third direction different from the first and second directions.

5. The display input apparatus according to claim 4, wherein
the first direction is one of a vertical direction and a horizontal direction,
the second direction is the other of the vertical direction and the horizontal direction, and
the third direction is a direction located between the first and second directions.

6. The display input apparatus according to claim 1, wherein when the gesture receiving section receives a scroll gesture moving from the intersecting region to the predetermined program entry region on the display, the display control section allows the program entry region to present the setting candidate presented in the intersecting region.

7. The display input apparatus according to claim 1, further comprising a control section configured to execute, when the gesture receiving section receives a predetermined program execution gesture, program execution processing based on the settings presented in the program entry region.

8. The display input apparatus according to claim 1, wherein the display control section is further configured to allow the display to provide the scrolling display of each of the setting item list and the setting candidate list in a cyclical manner.

9. A computer-readable non-transitory recording medium with a display input control program recorded thereon, the display input control program allowing a computer to function as:
a gesture receiving section configured to receive a user's gesture on a touch panel;
a display control section configured to control a display operation of a display according to a user's gesture received by the gesture receiving section; and
a program receiving section configured to receive a program consisting of a combination of settings of a plurality of setting items according to a user's gesture received by the gesture receiving section,
the display input control program further allowing the computer to function so that the display control section allows the display to display a setting item list composed of the plurality of setting items lined up in a first direction and a setting candidate list composed of a plurality of setting candidates listed for one of the plurality of setting items and lined up in a second direction different from the first direction, with the setting item list and the setting candidate list across each other, allows, when the gesture receiving section receives a scroll gesture in the first direction, the display to provide a scrolling display of the setting item list and display the setting candidate list composed of a plurality of setting candidates for the setting item presented in an intersecting region of the setting item list and the setting candidate list by the scrolling display, and allows, when the gesture receiving section receives a scroll gesture in the second direction, the display to provide a scrolling display of the setting candidate list,
the display input control program further allowing the computer to function so that when the gesture receiving section receives a scroll gesture moving from the intersecting region to a predetermined program entry region on the display, the program receiving section receives, as a setting forming part of the program, the setting candidate presented in the intersecting region.
